(19) United States
(12) Patent Application Publication
(10) Pub. No.: US 2006/0053463 A1
(43) Pub. Date: Mar. 9, 2006

(54) Image processing apparatus and method

(76) Inventor: In Chul Choi, Seongnam (KR)

Correspondence Address: PARK LAW FIRM, 3255 WILSHIRE BLVD, SUITE 1110, LOS ANGELES, CA, 90010, US

(21) Appl. No.: 11/189,480

(22) Filed: Jul. 26, 2005

(30) Foreign Application Priority Data
Sep. 6, 2004 (KR) 10-2004-0070708

(51) Int. Cl. H04N 7/173; H04N 7/16; H04N 5/44

(52) U.S. Cl. 725/131; 348/725; 725/100; 725/151

(57) ABSTRACT

The present invention relates to an image processing apparatus and method capable of capturing, storing, and replaying incoming image data and outputting currently-incoming image data or the captured image data on a display apparatus such as a monitor and a TV set.

### BACKGROUND OF THE INVENTION

1. Field of the Invention

The present invention relates to an image processing apparatus and method, and more particularly, to an image processing apparatus and method capable of capturing, storing, and replaying incoming image data and outputting currently-incoming image data or the captured image data on a display apparatus such as a monitor and a TV set.

2. Description of Related Art

Recently, the Internet has had a close relationship with human life. The IT technology has been greatly developed on the basis of the Internet. As a result, information can be rapidly and widely distributed through the Internet. On the Internet, there are a large number of virtual spaces called “web sites.” In addition, various kinds of networks have been developed to implement the infrastructure of the Internet. Therefore, any one accessing the Internet can easily acquire a variety of information from the web sites.

Although a variety of information can be easily obtained through the Internet, harmful information such as obscene information is also widely released without restriction. In particular, there is a problem in that adolescents may be exposed to the obscene information through the Internet at the home or the like.

In addition, there is a problem in that adults may spend too much time on the Internet. For example, some adults may carry out stock dealings or play a game on the Internet at the office, so that working efficiency may be lowered. Moreover, some adults are addicted to the Internet games and entertainments, so that they cannot lead a normal life. In addition, some criminals share their information with each other through the Internet to commit new kinds of Internet crimes. Increase in the Internet crime becomes a serious problem in society.

Conventionally, history of user's accessing the harmful or unnecessary information has not been effectively monitored by a supervisor. Only the approach is to restrict the user to accessing the internet by using PC usage restricting means such as magnetic or IC card. In this approach, the supervisor cannot monitor the detailed contents which the PC user has accessed.

On the other hand, similar to the Internet, TV broadcasting system may broadcast improper programs without restriction. Recently, TV programs have been marked with ratings based on ages which can be used as a parental guidance. However, the TV ratings scheme is a passively viewing restriction approach. If supervisors such as parents do not watch the TV together with their children, unsuitable or improper program may be viewed by the young children without restriction.

In addition, wide screen TV sets have been widely provided. When the wide screen TV set is not turned on, the blackened wide screen may spoil the appearance of a living room or the like where the TV set is disposed. Therefore, there have been demands for using the wide screen as a picture frame.

### SUMMARY OF THE INVENTION

In order to solve the aforementioned problems, an object of the present invention is to provide an image processing apparatus and method capable of capturing and storing image data output from a display apparatus such as a PC monitor or a TV set by using an image storing/processing unit provided within or outside the display apparatus and selectively outputting the stored image data in accordance with a user's selection or settings.

Another object of the present invention is to provide an image processing apparatus and method capable of capturing and storing image data output from a display apparatus such as a PC monitor by using an image storing/processing unit provided within or outside the display apparatus and selectively outputting the stored image data in accordance with a user's selection or settings, thereby monitoring PC user's using history.

Still another object of the present invention is to provide an image processing apparatus and method capable of capturing and storing image data output from a display apparatus such as a TV set by using an image storing/processing unit provided within or outside the display apparatus and selectively outputting the stored image data in accordance with a user's selection or settings, thereby monitoring TV viewer's viewing history.

Further still another object of the present invention is to provide an image processing apparatus and method capable of capturing and storing image data output from a display apparatus such as a PC monitor or a TV set by using an image storing/processing unit provided within or outside the display apparatus and outputting the stored image data when the display apparatus is not used, thereby using the display apparatus as a picture frame.

In order to achieve the objects of the present invention, according to an aspect of the present invention, there is provided an image processing apparatus for receiving incoming image data and outputting the image data to a display apparatus, comprising: a control unit for selectively capturing the received incoming image data; a storing unit for storing the captured image data; a control signal inputting unit for inputting a selection control signal; and a selecting/outputting unit for selecting one of currently-incoming image data and the captured image data stored in the storing unit and outputting the selected image data to the display apparatus.

According to another aspect of the present invention, there is provided an image processing apparatus for receiving an incoming image signal including a PC image signal, an SDTV image signal, or an HDTV image signal output from a video card of a computer and outputting the image signal to a display apparatus, comprising: an incoming image signal processing module for performing a predetermined a digital image signal process on the incoming image signal based on characteristics of thereof; a main processing module for selectively capturing and storing the incoming image signal output from the incoming image signal processing module; and an output signal processing module for selecting one of the incoming image signal output from the incoming image signal processing module and the captured image signal stored in the main processing module and outputting the selected image signal.

According to still another aspect of the present invention, there is provided an image processing apparatus for receiving an incoming analog CVBS image signal input from a TV receiving tuner and outputting the image signal to a display apparatus, comprising: a image storing/processing unit for selectively capturing the incoming analog CVBS image signal; a flash ROM for storing the captured image signal output from the image storing/processing unit; and a multiplexer for selecting one of the incoming analog CVBS image signal and the captured image signal stored in the flash ROM and outputting the selected image signal.

According to further still another aspect of the present invention, there is provided an image processing method of receiving incoming image data and outputting the image data to a display apparatus, comprising steps of: selectively capturing the received incoming image data; storing the captured image data; and selecting one of currently-incoming image data and the captured image data stored in a storing unit and outputting the selected image data to the display apparatus.

### BRIEF DESCRIPTION OF THE DRAWINGS

The above and other features and advantages of the present invention will become more apparent by describing in detail exemplary embodiments thereof with reference to the attached drawings in which:

FIG. 1A is a block diagram showing a display apparatus and image processing apparatus provided within the display apparatus according to the present invention;

FIG. 1B is a block diagram showing a display apparatus and image processing apparatus provided outside the display apparatus according to the present invention;

FIG. 2 shows an image processing apparatus adapted to a monitor according to a first embodiment of the present invention;

FIG. 3 is a block diagram showing an image processing apparatus adapted to a TV set according to a second embodiment of the present invention;

FIG. 4 is a block diagram showing incoming signal processing components of an image storing/processing unit according to the embodiment of the present invention;

FIG. 5 is a block diagram showing main processing components of the image storing/processing unit according to the embodiment of the present invention;

FIG. 6 is a schematic diagram showing the output signal processing components of the image storing/processing unit according to the embodiment of the present invention;

FIG. 7 is a block diagram showing control signal processing operations of the image storing/processing unit according to the embodiment of the present invention;

FIG. 8 is a flowchart showing processes of a down scaler of the image storing/processing unit according to the present invention;

FIG. 9 is a flowchart showing a compressing process of the image data compressing unit of the image storing/processing unit according to the embodiment of the present invention;

FIG. 10 is a flowchart showing a decompressing process of the image data compressing unit of the image storing/processing unit according to the present invention; and

FIG. 11 is a flowchart showing a process of capturing, storing, and replaying image data in the image processing apparatus according to the present invention.

### DETAILED DESCRIPTION OF THE INVENTION

The attached drawings for illustrating exemplary embodiments of the present invention are referred to in order to gain a sufficient understanding of the present invention, the merits thereof, and the objectives accomplished by the implementation of the present invention.

Hereinafter, the present invention will be described in detail by explaining exemplary embodiments of the invention with reference to the attached drawings. Like reference numerals in the drawings denote like elements.

The present invention provides an image processing apparatus and method of capturing and storing image data and selectively outputting the image data on a display apparatus. The image processing apparatus may be provided within or outside the display apparatus. The display apparatus employed in the present invention includes, for example, a monitor such as an LCD monitor and a PDP monitor using a flat panel display apparatus such as an LCD apparatus and a PDP apparatus, a TV set such as an LCD TV set and a PDP TV set, an analog TV set, a digital TV set such as a SDTV set and a HDTV set, and any other apparatuses for displaying image.

In other words, the present invention is adapted to the TV set such as a TV display apparatus, a cable TV set-top apparatus, and a satellite broadcast set-top apparatus as well as a PC (personal computer) monitor connected to the PC. The PC monitor displays the image output from the VGA card installed in the PC. Hereinafter, the PC monitor and the TV set are collectively referred to as a “display apparatus.” The aforementioned term “image” includes an image containing audio data as well as a pure image including a still picture as well as a motion picture.

In addition, according to the present invention, the currently-incoming image signal in the image processing apparatus is captured and stored by the image storing/processing unit and the captured image signal is output in accordance with a user's selection or a user's settings, if necessary. Preferably, in order to improve storage efficiency, the captured image data is compressed before stored in the storing unit.

In addition, in the present invention, with respect to the capturing location, the image signal (analog signal) input to the image processing apparatus or the image signal (digital signal) input to the display apparatus may be captured.

Therefore, according to the present invention, the image processing apparatus provided within or outside the display apparatus comprises a unit for capturing the image signal, a unit for compressing and storing the captured image data, and a unit for decompressing the compressed stored image data and outputting the image data.

In addition, the capturing time when the incoming image signal is captured and the displaying time when the stored image data is output and displayed are determined in accordance with the user's selection or settings.

In a case where the image processing apparatus according to the present is used as a monitoring apparatus, the incoming image data may be periodically captured and stored. The captured image data stored in the storing unit may be selectively output and displayed at a supervisor's desired time. In this case, verification means may be provided, so that the captured image signal can be monitored by only the verified supervisor having a right to output the captured image data.

In a case where the user desires to capture an image with the image processing apparatus according to the present invention when watching the TV set, the user captures and stores the image using a control signal inputting unit such as a remote controller or an input button. The captured image can be displayed when the user desires to see the image.

In addition, according to the present invention, the captured image data stored in the storing unit may be output in accordance with the user's settings. For example, the captured image data may be selected and output at a specific time or at a user's desired time.

In addition, the image processing apparatus according to the present invention is adapted to a picture frame. When there is no the image data output to the display apparatus, for example, when the display apparatus is turned off, the captured image data can be automatically displayed on the display apparatus by using a picture frame power supplying mode.

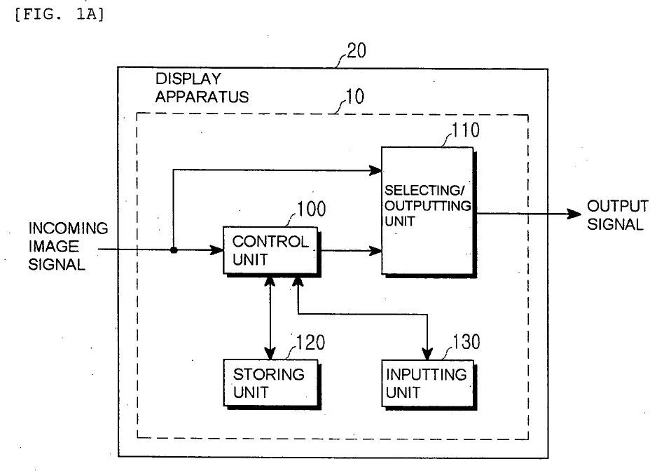

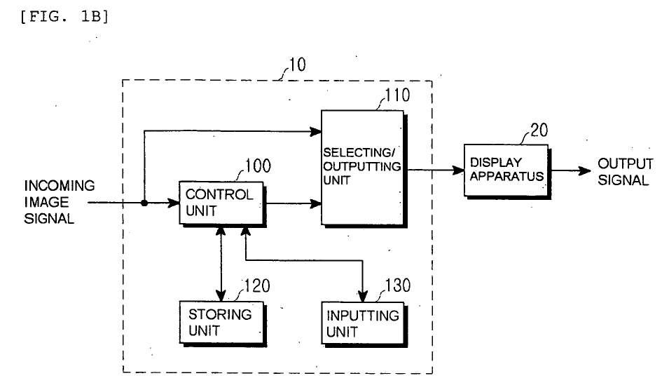

Now, the image processing apparatus according to the present invention will be described with reference to FIGS. 1A and 1B. FIG. 1A is a block diagram showing the display apparatus and the image processing apparatus provided within the display apparatus according to the present invention. FIG. 1B is a block diagram showing the display apparatus and the image processing apparatus provided outside the display apparatus according to the present invention;
More specifically, the image processing apparatus for capturing, storing, and replaying the image data may be implemented with a chip set board within the display apparatus. Alternatively, the image processing apparatus may be separately provided outside the display apparatus.

As shown in FIG. 1A, an image processing apparatus 10 according to the present invention may be implemented within the display apparatus 20. In the present invention, since the display apparatus 20 may be any display apparatus, description of construction thereof is omitted.

Alternatively, as shown in FIG. 1B, the image processing apparatus 10 may be separately implemented outside the display apparatus 20. In this case, before the image data is input to the display apparatus 20, the image processing apparatus 10 perform a predetermined process on the image data and inputs the processed image data to the display apparatus 20.

Now, the construction of the image processing apparatus 10 provided inside or outside the display apparatus 20 will be schematically described with reference to FIGS. 1A and 1B.

The image processing apparatus 10 may be provided within or outside the display apparatus 20. Referring to FIGS. 1A and 1b, the image processing apparatus 10 comprises a control unit 100 for capturing a currently-incoming image signal; a storing unit 120 for storing the captured image signal; a control signal inputting unit 130 for inputting a capture control signal and a selection control signal, and a selecting/outputting unit 110 for selecting and outputting one of the currently-incoming image signal and the captured image signal stored in the storing unit in response to the selection control signal and outputting the selected image signal.

The currently-incoming image signal output from the image processing apparatus 10 can be display in real-time on the flat panel display apparatus 20. According to the present invention, the currently-incoming image signal is input to the control unit 100. The control unit 100 captures the currently-incoming image signal in response to the capture control signal input from the control signal inputting unit 130. The captured image signal is stored in the storing unit 120. Here, in order to increase storage efficiency, the captured image signal may be compressed by a predetermined image data compressing unit (not shown) before stored in the storing unit 120.

On the other hand, in response to the selection control signal input from the control signal inputting unit 130 through the control unit 100, the selecting/outputting unit 110 selects one of the currently-incoming image signal and the captured image signal stored in the storing unit and outputs the selected image signal to the display apparatus 20.

In a normal situation, where a user performs a general task on the PC or watches the TV set, the selecting/outputting unit 110 selects the currently-incoming image signal in the image processing apparatus 10 and outputs the currently-incoming image signal to the display apparatus 20. The currently-incoming image signal is displayed on the display apparatus 20. On the other hand, when the user inputs the capture control signal by using the control signal inputting unit 130, the currently-incoming image signal in the image processing apparatus is captured by the control unit 100 and stored in the storing unit 120. In addition, the captured image signal stored in the storing unit 120 can be output to the display apparatus 20 in accordance with the selection control signal input though the control signal inputting unit 130 by the user. Instead of the currently-incoming image signal, the captured image signal stored in the storing unit 110 is displayed on the display apparatus 20. Preferably, verification means such as password identifying means or IC cards may be provided to the control signal inputting unit 130, so that the captured image signal can be monitored by only the verified supervisor having a right to output the captured image data.

In addition, although the capturing operation of the control unit 100 is activated in response to the capture control signal input from the control signal inputting unit 130, the capturing operation may be performed periodically or at a specific time Alternatively, the usage time interval of the display apparatus 20 may be set and the control unit 100 may be automatically turned on and off in accordance with the usage time interval. Preferably, a usage time setting unit (not shown) may be separately provided in order to automatically turn on and off the display apparatus 20 in accordance with a set usage time thereof.

In the embodiment, the captured image signal stored in the storing unit 120 is selected and output by the selecting/outputting unit 110 when the selection control signal is input from the control signal inputting unit 130. Alternatively, the captured image signal stored in the storing unit 120 can be arranged to be output when there is no currently-incoming image signal output from a VGA card of the PC or input to the TV set.

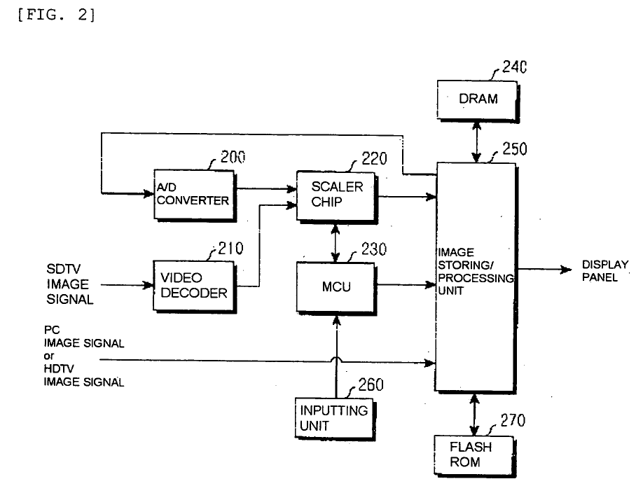

Now, an image processing apparatus 10 adapted to a PC or a TV set according to an embodiment of the present invention will be described with reference to FIGS. 2 to 7. The image processing apparatus 10 is provided within or outside the aforementioned display apparatus 20.

Image signals with various resolutions output from the PC computer are classified into two types thereof. The first type is an analog RGB image signal. The second type is a digital video interface (DVI) signal, which is obtained by converting a digital RGB image signal in a TTL (transistor-transistor logic) format to a differential signal. The DVI signal includes, for example, a standard low voltage differential signal (LVDS) and a transition minimized differential signal (TMDS).

In general, the TV set receives an analog signal. However, a TV set having a set-top function or an external set-top apparatus can receive a digital signal.

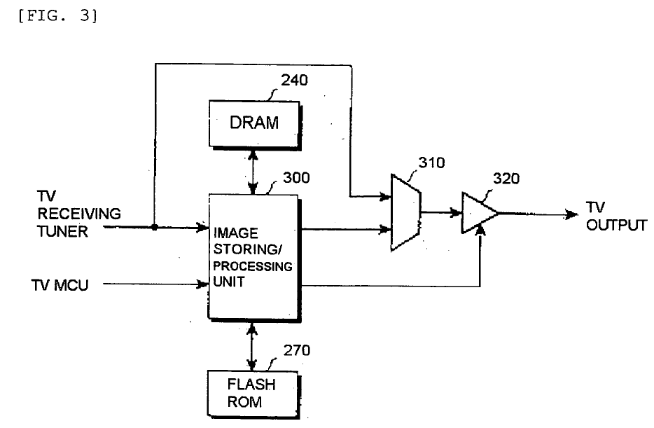

The image processing apparatus is adapted to a monitor and a TV set according to first and second embodiments shown in FIGS. 2 and 3, respectively.

### First Embodiment

FIG. 2 shows the image processing apparatus 10 according to the first embodiment. In the first embodiment, the monitor includes an SDTV or HDTV monitor such as an LCD TV monitor and a PDP TV monitor as well as a PC monitor such as an LCD monitor.

Referring to FIG. 2, the image processing apparatus 10 comprises an A/D converter 200, a video decoder 210, a scaler chip 220, a micro controller unit (MCU) 230, a DRAM 240, an image storing/processing unit 250, a control signal inputting unit 260, and a flash ROM 270.

The image processing apparatus 10 according to the first embodiment can be installed on a digital image signal processing and control board within the flat panel display apparatus such as the LCD monitor and the LCD or PDP TV monitor. Alternatively, the image processing apparatus 10 may be provided outside the display apparatus. In addition, the image processing apparatus 10 may be provided within or outside a projection TV set or a projector thereof.

The image signal input to the image processing apparatus 10 includes, for example, a PC image signal output from the personal computer, an SDTV image signal, and an HDTV image signal.

Since the SDTV image signal has an analog CVBS (Composite Video Broadcast Signal or Blanking Signal or Burst Sync) signal in the NTSC (National Television System Committee) or PAL (Phase Alternating Line) format, the SDTV image signal is converted to a digital signal by the video decoder 210.

The PC image signal (analog RGB image signal) and the HDTV image signal (analog YPbPr image signal) are input to the A/D converter 200 through the image storing/processing unit 250 and converted to a digital sign-al.

Firstly, a signal processing operation on the SDTV image signal in the image processing apparatus will be described in detail. The SDTV image signal (analog CVBS image signal in the NTSC or PAL format) is converted to a digital YUV image signal by the video decoder 210. Next, the digital YUV image signal is input to the scaler chip 220.

On the other hand, the PC image signal (analog RGB image signal) and the HDTV image signal (analog YPbPr image signal) are converted to digital RGB image signals in the TTL format by the A/D converter 200. The PC image signal and the HDTV image signal converted to the digital RGB image signals are input to the scaler chip 220.

The scaler chip 220 converts the digital YUV image signal output from the video decoder 210 to a digital RGB image signal. Next, the scaler chip 220 selects one of the digital RGB image signal output from the A/D converter 200 and the digital RGB image signal converted from the digital YUV image signal. The selected digital RGB image signal is scaled based on the resolution and frequency of the flat panel display apparatus. The scaled digital RGB image signal is input to the flat panel display apparatus through the image storing/processing unit 250.

Here, various types of digital signals such as digital RGB, TMDS, and LVDS signals may be used for the flat panel display apparatus. In general, the LVDS signal is used for the flat panel display apparatus.

The MCU 230, a computer, has functions of initializing various functional blocks, detecting control signals output from a button key or an IR (infrared) remote controller, and performing various control operations in response to the control signals. For example, the MCU 230 controls the scaler chip 220 and the image storing/processing unit 250 in response to a control signal input from the control signal inputting unit 260 or a previously-set control signal.

For example, the MCU 230 may control an input image signal selecting operation and an output signal formatting operation of the scaler chip 220. In addition, in order to control the image storing/processing unit 250, the MCU 230 inputs the I2C signals such as SCL (serial clock line) and SDL (serial data line) signals.

According to the present invention, the digital image signal transmitted from the scaler chip 220 to the image storing/processing unit 250 can be captured in accordance with user's settings or in a predetermined capturing period. The captured digital image signal is compressed and stored in a predetermined storing unit. After that, the image storing/processing unit 250 selects one of the currently-incoming image signal and the captured image signal stored in the storing unit and outputs the selected image signal to the flat panel display apparatus.

The DRAM 240 temporarily stores the captured image signal in units of a frame. The flash ROM 270 stores the digital image data compressed by the image storing/processing unit 250.

The compressed image data stored in the flash ROM 270 is read out by the image storing/processing unit 250 in accordance with the user's selection or settings. The read-out compressed image data is decompressed and output to the flat panel display apparatus.

The detailed structure and operations of the image storing/processing unit 250 will be described later.

### Second Embodiment

FIG. 3 is a block diagram showing an image processing apparatus 10 adapted to a TV set according to a second embodiment of the present invention

Referring to FIG. 3, the image processing apparatus according to the second embodiment comprises a DRAM 240, an image storing/processing unit 300, a control signal inputting unit 260, a flash ROM 270, a multiplexer 310, and a switching unit 320.

Firstly, an analog CVBS image signal output from a TV receiving tuner is input to the image storing/processing unit 300. In addition, in order to control the image storing/processing unit 300, 12C signals, that is, SDL and SCL signals are input to the image storing/processing unit 300.

The image storing/processing unit 300 captures and compresses the incoming image signal and stores the compressed image signal to the flash ROM 270 in a similar manner shown in FIG. 2. Since the TV receiving signal is generally an analog signal, it is preferable that the TV receiving signal be converted to a digital signal before input to the image storing/processing unit 300 for convenience of storage and efficiency. If the TV receiving signal is a digital signal, the analog-to-digital conversion may be omitted.

The image storing/processing unit 300 outputs the captured image signal stored in the flash ROM 270 to the multiplexer 310 in accordance with user's selection or settings. The multiplexer 310 selectively outputs one of the captured image signal output from the image storing/processing unit 300 and the currently-incoming image signal output in real time from the TV receiving tuner. Here, the multiplexer 310 performs the selection process based on a selection control signal, which may be generated by an MCU (not shown) of the TV set or a predetermined control signal inputting unit (not shown).

The image signal selected by the multiplexer 310 is finally output as TV output signal in accordance with on/off control of the switching unit 320. Here, the image storing/processing unit 300 may provide an on/off control signal to the switching unit 320.

As described above, various incoming image signals such as a TV signal, an SDTV signal, an HDTV signal, and a PC signal can be processed in accordance with a predetermined signal processing procedure of the present invention.

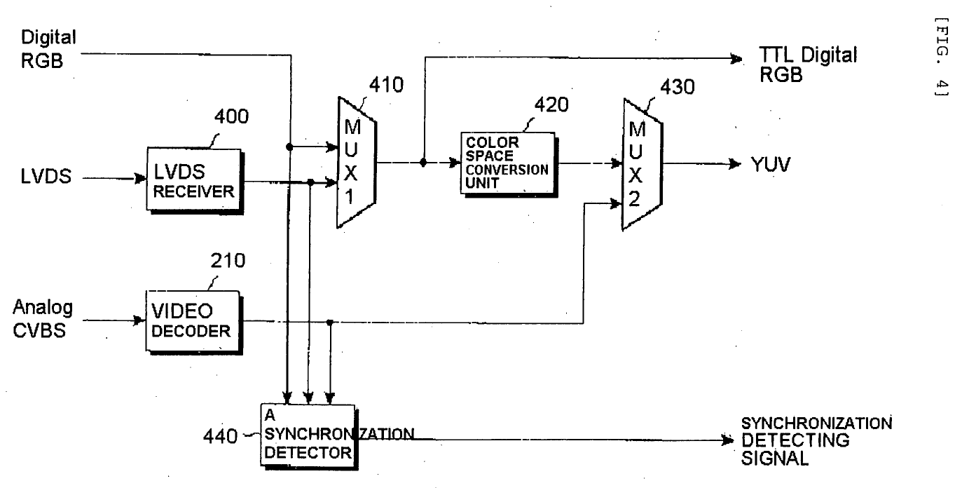

Now, detailed components of the image storing/processing unit 250 or 300 such as incoming signal processing components, main processing components, and output signal processing components will be described with reference to FIGS. 4 to 7. The components shown in FIGS. 4 to 7 include the image storing/processing unit 250 or 300 and the incoming signal and output signal processing components of the image storing/processing unit 250 or 300 shown in FIGS. 2 and 3.

FIG. 4 is a block diagram showing incoming signal processing components of the image storing/processing unit 250 or 300 according to the embodiment of the present invention.

Referring to FIG. 4, the image storing/processing unit 250 or 300 comprises an LVDS receiver 400, a first multiplexer MUX-1 410, a color space conversion unit 420, a second multiplexer MUX-2 430, a video decoder 210, a synchronization detector 440.

The digital RGB image signal output from the aforementioned scaler chip 220 is input to the first multiplexer MUX-1 410. The LVDS signal is input to the LVDS receiver 400. In the LVDS receiver 400, the digital RGB image signal and the synchronization signals Hsync and Vsync are extracted from the LVDS signal. The digital RGB image signal output from the LVDS receiver 400 is input to the first multiplexer MUX-1 410. The extracted control signal is input to the synchronization detector 440.

The analog CVBS image signal is input through the video decoder 210 to the image storing/processing unit 250 or 300. The analog CVBS image signal includes for example NTSC and PAL signal. The video decoder 210 has a function of converting the analog CVBS image signal to a digital YUV image signal. The digital YUV image signal converted by the video decoder 210 is input to the second multiplexer MUX-2 430.

On the other hand, the synchronization detector 440 detects synchronization signals from the signals input to the image storing/processing unit 250 or 300: the digital RGB image signals input to the first multiplexer MUX-1 410; the digital RGB image signals output from the LVDS receiver 400; and the digital YUV image signals output from the video decoder 210, in order to determine whether or not the image signal is valid. And then, the synchronization detector 440 outputs a synchronization detecting signal.

The first multiplexer MUX-1 410 selects one of the directly-input digital RGB image signal and the digital RGB image signal output from the LVDS receiver 400. The digital RGB image signal selected by the first multiplexer MUX-1 410 is a TTL level digital RGB image signal, which is directly output to a flat display panel or input to the color space conversion unit 420 in order to capture or store.

In the color space conversion unit 420, the digital RGB image signal output from the first multiplexer MUX-1 410 is converted to the digital YUV image signal. The digital YUV image signal is an image signal used to expand, compress and decompress the image signal. For example, a YUV 422 format signal may be used as a digital YUV image signal. The digital YUV image signal output from the color space conversion unit 420 is input to the second multiplexer MUX-2 430.

The second multiplexer MUX-2 430 selects one of the digital YUV image signal output from the color space conversion unit 420 and the digital YUV image signal output from the video decoder 210. Here, the digital YUV image signal output from the second multiplexer MUX-2 430 can be captured and stored by the main processing unit of the image storing/processing unit 250 or 300.

In summary, in the incoming signal processing components, the physical connection is selected based on the type of the incoming image signal: the digital RGB image signal and the digital LVDS image signal, as shown in FIG. 2. In addition, the selection of the incoming image signal is physically implemented with the first multiplexer 410. In addition, the digital RGB image signal selected by the first multiplexer MUX-1 410 is converted to a YUV format signal by the color space conversion unit 420, which is to be used by the main processing components. In case of the LVDS signal, the digital RGB image signal converted by the LVDS receiver 400 is converted to the YUV format signal by the color space conversion unit 420. In addition, the selected digital RGB image signal is input to the output signal processing block to be bypassed to the display panel.

The first multiplexer MUX-1 410 or the second multiplexer MUX-2 430 selects a signal based on presence type of an image signal input to the display apparatus 20. The image signal includes, for example, an SDTV image signal, an HDTV image signal, a PC image signal, and a TV signal. In case of selecting the SDTV signal, the second multiplexer MUX-2 430 selects the signal output from the video decoder 210.

Up to now, the incoming signal processing components for processing the incoming image signal and the LVDS signal are described with reference to FIG. 2. In case of the TV image signal as shown in FIG. 3, the analog CVBS image signal is converted to the digital YUV image signal by the video decoder (not shown), that is, a digitizer provided within or outside the image storing/processing unit 300 to be used for the later-described main processing components.

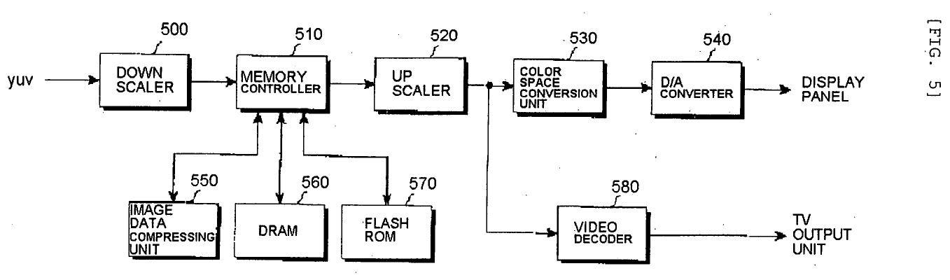

Up to now, the incoming signal processing components of the image storing/processing unit 250 or 300 according to the embodiment of the present invention have been described. Now, the main processing components for capturing, compressing, and storing the digital YUV image signal output from the incoming signal processing components will be described with reference to FIG. 5.

FIG. 5 is a block diagram showing the main processing components of the image storing/processing unit 250 or 300 according to the embodiment of the present invention.

Referring to FIG. 5, the main processing components of the image storing/processing unit 250 or 300 include a down scaler 500, a memory controller 510, an up scaler 520, a color space conversion unit 530, a D/A converter 540, an image data compressing unit Codec 550, a DRAM 560, a flash ROM 570, and a video encoder 580.

The digital YUV image signal output from the second multiplexer MUX-2 430 of FIG. 4 is input to the down scaler 500. The digital YUV image signal input to the down scaler 500 is a signal finally selected from various incoming image signals input to the image storing/processing unit 250 or 300 and compressed and stored by the main processing components.

The down scaler 500 has a function of down-scaling the incoming image signal to equalize the resolution thereof. As a result, the incoming video frame, that is, a singe screen image, is reduced down to a size suitable to be stored in a storage medium, that is, the DRAM 560.

The down-scaled input signal is compressed by the image data compressing unit Codec 550. The compressed image signal is temporarily stored in the DRAM 560. The DRAM 560 temporarily stores the incoming video frame, the compressed image signal output from the image data compressing unit Codec 550, or the video frame which is to be decompressed and output.

On the other hand, the image data compressing unit Codec 550 has a function of decompressing the compressed signal stored in the DRAM 560. The memory controller 510 has a function of controlling timing of the DRAM 560, the flash ROM 570, and the image data compressing unit Codec 550.

The image data compressing unit Codec 550 compresses the image data in units of a frame in accordance with a predetermined compressing method. The predetermined compressing method includes, for example, the JPEG (Joint Photographic Experts Group) compressing method, the MPEG (Motion Picture Expert Group) compressing method, the AVI (Audio Visual Interleaved) compressing method, and the MOV compressing method. In addition, it is obvious that other compressing methods can be adapted to the present invention.

Finally, the compressed video frame data is stored in the flash ROM 570.

The compressed image data stored in the DRAM 560 is read out and decompressed by the memory controller 510 in order to be replayed. The decompressed image data is transmitted to the up scaler 520. The up scaler 520 has a function of adjusting the size of the decompressed image data suitable for the resolution of the screen in order to recover and display the decompressed image data on the screen of the display apparatus.

The output signal of the up scaler 520 is input through the color space conversion unit 530 to the display apparatus such as a monitor or through the video encoder 580 to a TV monitor.

Since the decompressed video frame is a digital YUV image signal, the decompressed video frame must be converted to a digital RGB image signal in order to be displayed on the screen of the display apparatus. The color space conversion unit 530 converts the input digital YUV image signal to the digital RGB image signal.

The converted digital RGB image signal is input to the D/A converter 540. The D/A converter 540 converts the input digital RGB image signal to an analog RGB image signal.

On the other hand, the video encoder 580 converts the input digital YUV image signal to an analog CVBS image signal. Since the digital YUV image signal can be input to the video encoder 580 as its format is, there is no need for a separate color space conversion unit 530 unlike the monitor output signal.

As described above, the image signal which are captured, compressed and stored by the main processing components can be decompressed in accordance with the user's selection or settings. In addition, the signal together with the signal bypassed to the incoming signal processing components is transmitted to output signal processing components.

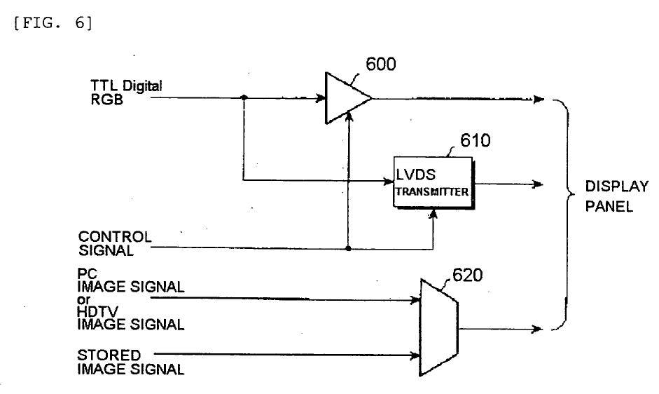

Now, the output signal processing components for outputting the transmitted signal to a display panel or a TV output device will be described with reference to FIG. 6.

FIG. 6 is a schematic diagram showing the output signal processing components of the image storing/processing unit 250 or 300.

Referring to FIG. 6, the output signal processing components of the image storing/processing unit 250 or 300 include a switching unit 600, an LVDS transmitter 610, and a multiplexer 620.

The digital RGB image signal bypassed from the first multiplexer MUX-1 410 is input to the switching unit 600 and the LVDS transmitter 610. The digital RGB image signal input to the switching unit 600 is selectively output to the display apparatus in accordance with the on/off operation of the switching unit 600. The digital RGB image signal input to the LVDS transmitter 610 is converted to an LVDS signal, and then, selectively output to the display apparatus.

More specifically, a control signal for connecting or disconnecting the image signal to the display panel or the TV screen is input to the switching unit 600 and the LVDS transmitter 610. In response to the input control signal, the digital RGB image signal or the LVDS signal is selectively output to the display apparatus.

When the display panel is in an off state, the output signals of the switching unit 600 and the LVDS transmitter 610 are in a high-impedance state.

On the other hand, the PC image signal (analog RGB image signal) and the HDTV image signal (analog YPbPr image signal) of FIG. 2 and the analog RGB image signal output from the D/A converter 540 of FIG. 5 are input to the multiplexer 620 of the image storing/processing unit 250.

In case of directly outputting a currently-incoming image, the incoming PC image signal (analog RGB image signal) or the HDTV image signal (analog YPbPr image signal) is output in response to a selection control signal of the multiplexer 620. In case of outputting a previously stored image, the analog RGB image signal (the previously stored image) output from the D/A converter 540 of FIG. 5 is output. The output signal of the multiplexer 620 is transmitted to the display panel.

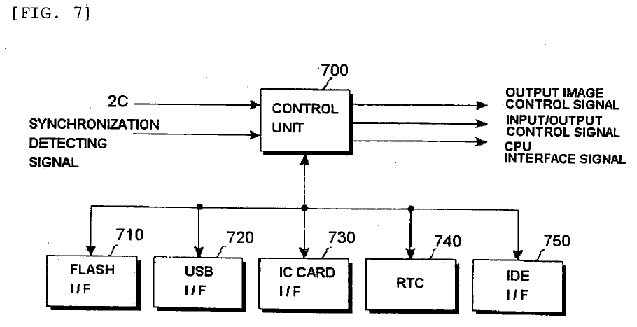

Up to now, the incoming signal processing components, the main processing components and the output signal processing components of the image storing/processing unit 250 or 300 according to the embodiment of the present invention have been described with reference to FIGS. 4 to 6. Now, control signal processing components of the image storing/processing unit 250 or 300 will be described with reference with FIG. 7.

FIG. 7 is a block diagram showing control signal processing operations of the image storing/processing unit 250 or 300 according to the embodiment of the present invention.

Referring to FIG. 7, an I2C control signal and a synchronization detection signal are input to the control unit 700. The I2C control signal is input from the MCU 230, which processes the image signals of the image storing/processing unit 250 or 300 as described above with reference to FIG. 2. The synchronization detection signal is used to determine whether or not the image is valid based on the input signal output from the synchronization detect unit 440 as described above.

On the other hand, the control unit 700 interfaces with various peripheral devices. The peripheral devices include, for example, a flash I/F (Flash Interface) 710, a USB I/F (Universal Serial Bus Interface) 720, an IC card I/F (Integrated Circuit Card Interface) 730, an RTC (Real Time Clock) 740, and an IDE I/F (Integrated Drive Electronics Interface) 750.

The control unit 700 outputs control signals such as an output image control signal, an input/output control signal, and a CPU interface signal. The output image control signal is used to control the on/off operations of the switching unit 320 of FIG. 3 and the switching unit 600 and the LVDS transmitter 610 of FIG. 6.

The input/output control signal is input to an I/O port used to control input/output operations of a whole system. The CPU interface signal is input to a CPU interface port used to control the image storing/processing unit 250 or 300 or the incoming signal processing components thereof according to the present invention, which may be provided within or outside the display apparatus. By using the CPU interface port, the CPU is efficiently used, so that the cost of the whole system can be reduced.

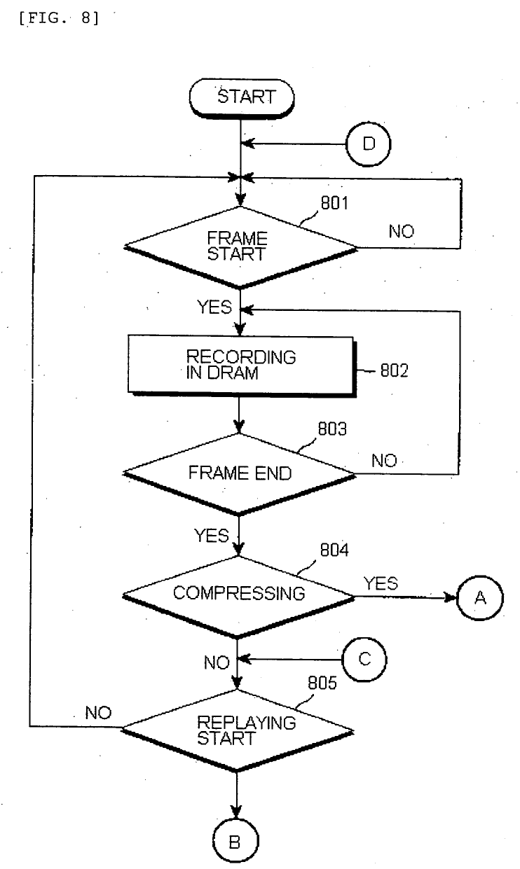

Up to now, the image storing/processing unit of capturing, storing, replaying image data and outputting the image data to the display apparatus according to the embodiment of the present invention have been described with reference to FIGS. 2 to 7. Now, main processing components of the image storing/processing unit will be described with reference to FIGS. 8 to 10.

FIG. 8 is a flowchart showing processes of a down scaler of an image storing/processing unit according to the present invention.

Referring to FIG. 8, the down scaler 500 determines whether or not the frame of the incoming image signal starts (S801). Since the capturing and compressing processes of the down scaler 500 are performed in units of a frame, it is preferable to determine the starting and ending of the frame of the image signal. If the frame of the image signal is determined to start, the image signal is recorded in the DRAM (S802). While the image signal is recorded, it is determined whether or not the frame of the image signal ends (S803).

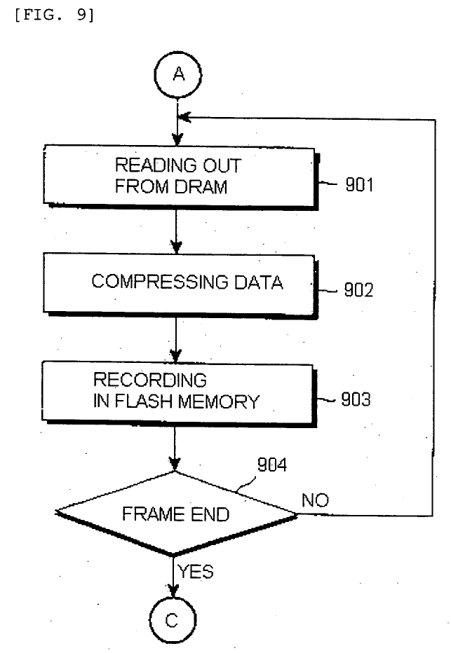

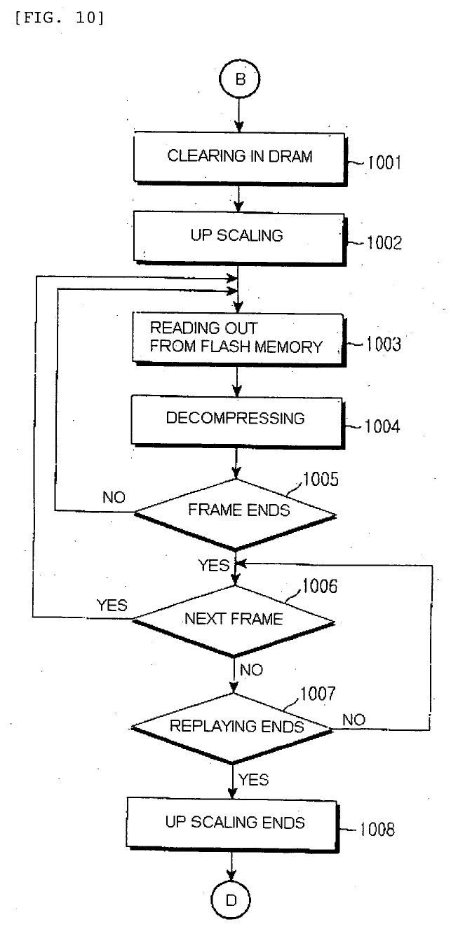

If the frame of the image signal is determined to end, the frame of the image signal stored in the DRAM is compressed (S804) or replayed (S805). When the frame of the image signal is compressed, the procedure proceeds to the process A of FIG. 9. When the frame of the image signal is replayed, the procedure proceeds to the process of B of FIG. 10.

FIG. 9 is a flowchart showing a compressing process of the image data compressing unit of the image storing/processing unit according to the embodiment of the present invention.

Referring to FIG. 9, when the image signal recorded in the DRAM in units of a frame is determined to be compressed in FIG. 8, the image data compressing unit performs the compressing process as follows.

Firstly, the image signal stored in the DRAM in units of a frame is read out (S901). Next, the read-out data, that is, the image signal, is compressed in accordance with a predetermined compressing method (S902). The compressed image data is recorded in the flash ROM, that is, the flash memory (S903). Since the compressing process is preferably performed in units of a frame, it is determined whether or not the frame ends after the compressing process is completed (S904). If the frame ends, the procedure proceeds to the step S805 of determined whether or not the replaying process is performed.

FIG. 10 is a flowchart showing a decompressing process of the image data compressing unit of the image storing/processing unit according to the present invention.

Referring to FIG. 10, when the compressed image signal stored in the flash memory in units of a frame is to be replayed, the compressed image signal is decompressed by the image data compressing unit, and then, replayed.

When the compressed image signal stored in the DRAM is determined to be replayed in the step S805 of FIG. 8, the image data stored in the DRAM is cleared (S1001). This is because not the currently-incoming image signal but the previously stored image data is to be replayed. Therefore, it is preferable that the current incoming image signal temporarily stored in the DRAM be cleared.

Next, as described above, an up scaling process is performed (S1002). The compressed image signal stored in the flash memory is read out (S1003).

Since the read-out image signal is a compressed signal, the read-out image signal is decompressed in accordance with a predetermined decompressing method (S1004). Next, it is determined whether or not the frame is to end (S1005). If it is determined that the frame ends, it is determined whether or not the next frame of the image signal is to be replayed (S1006). If it is determined that the frame does not end, the aforementioned processes (S1003 and S1004) are repeated.

If it is determined that the next frame is to be replayed, the aforementioned processes (S1003 to S1005) are repeated. If it is determined that the next frame is not to be replayed, it is determined whether or not the replaying process is to end (S1007). If it is determined that the replaying process is not to end, the aforementioned process (S1006) is repeated. If it is determined that the replaying process is to end, the up scaling process ends (S1008).

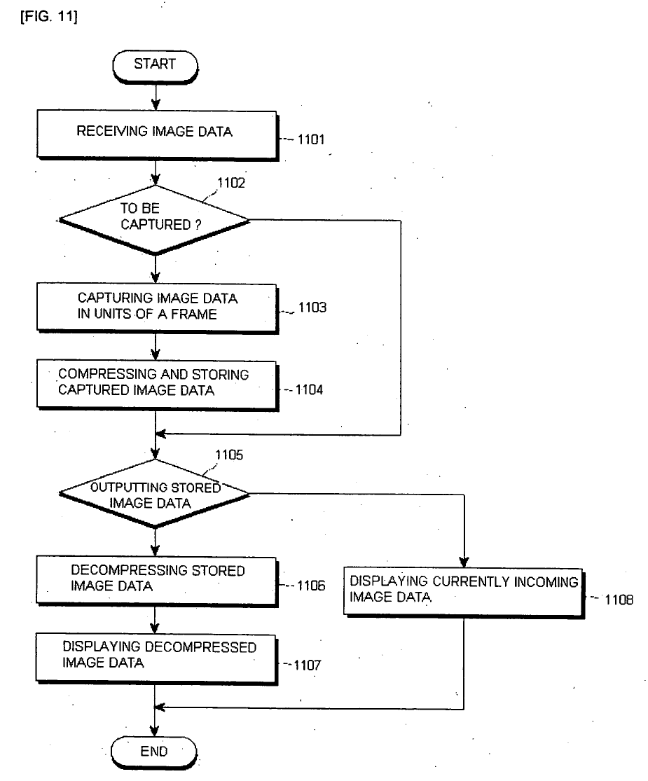

Now, an image processing procedure performed by the image processing apparatus of FIGS. 1A and 1b according to the present invention will be described with reference to FIG. 11.

FIG. 11 is a flowchart showing a process of capturing, storing, and replaying image data in the image processing apparatus according to the present invention.

Referring to FIG. 11, firstly the image processing apparatus receives the external image data (S1101). Next, the received incoming image data is captured and stored by the image processing apparatus. The image data is output to the display apparatus for displaying the image. As described above, the display image includes a TV set, a monitor, and any image output apparatuses.

In general, the received incoming image data input to the image processing apparatus is displayed in real-time on the display apparatus.

On the other hand, the received incoming image data can be captured and stored by the user's selection or settings according to the present invention. If the received incoming image data is determined to be captured (S1102), the received incoming image data is captured in accordance with the aforementioned manner. Here, it is preferable that the image data be captured in units of a frame (S1103). In addition, the captured image data is compressed in a predetermined compressing method and stored in a storage medium (S1104).

Next, it is determined which of the currently-incoming image data and the previously stored image data is output (S1105). If the currently-incoming image data is determined to be output, the currently-incoming image data is displayed on the display apparatus (1108).

On the other hand, if the previously stored image data is determined to be output, the compressed image data stored in the image processing apparatus is decompressed (S1106), and the decompressed image data is displayed on the display apparatus (S1107).

Accordingly, the currently-incoming image data is displayed on the display apparatus irrespective of the type of the incoming image signal. Otherwise, the currently-incoming image data is captured, compressed, and stored, and then, the stored image data is displayed on the display apparatus.

In addition, it is obvious that various verification means is provided, so that the captured image signal can be monitored by only the verified supervisor having a right to output the captured image data.

In addition, an image processing apparatus for capturing, storing, and replaying the output image data according to the present invention may be provided outside the display apparatus as well as within the display apparatus. In other words, the image processing apparatus outside the display apparatus such as a TV monitor or a computer monitor stores the image data and selectively outputs the image to the display apparatus.

In case of providing the image processing apparatus outside the display apparatus, it is possible to easily attach and detach the image processing apparatus to the display apparatus and to separately control the image processing apparatus and the display apparatus.

According to the present invention, since image data output from a PC monitor is stored in a unit provided within or outside the PC monitor and the stored image data is selectively output in accordance with a user's selection or settings, it is possible to easily monitor PC user's using history.

In addition, according to the present invention, since image data output from a TV set is stored in a unit provided within or outside the TV set and the stored image data is selectively output in accordance with a user's selection or settings, it is possible to easily monitor TV viewer's viewing history.

In addition, according to the present invention, since image data output from a TV set is stored in a unit provided within or outside the TV set and the stored image data is output when the display apparatus is not used, it is possible to use the display apparatus as a picture frame.

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. An image processing apparatus for receiving incoming image data and outputting the image data to a display apparatus, comprising:
a control unit for selectively capturing the received incoming image data;
a storing unit for storing the captured image data;
a control signal inputting unit for inputting a selection control signal; and
a selecting/outputting unit for selecting one of currently-incoming image data and the captured image data stored in the storing unit and outputting the selected image data to the display apparatus.

2. The image processing apparatus according to claim 1, further comprising an image data compressing unit for compressing the captured image data and transmitting the compressed image data to the storing unit.

3. The image processing apparatus according to claim 1, wherein the display apparatus is a monitor for displaying one of a SDTV image signal, a PC image signal, and an HDTV image signal.

4. The image processing apparatus according to claim 1, the display apparatus is a TV set for displaying a TV signal.

5. The image processing apparatus according to claim 1, wherein the control unit periodically captures the incoming image data input to the display apparatus.

6. The image processing apparatus according to claim 1, wherein the selecting/outputting unit selects the image data in accordance with the selection control signal input from the control signal inputting unit and outputs the selected image data.

7. The image processing apparatus according to claim 1, wherein, when there is no currently-incoming image data, the selecting/outputting unit outputs the image data stored in the storing unit to the display apparatus.

8. The image processing apparatus according to claim 1, wherein the control signal inputting unit further comprises verification means for verifying a right to output the captured image data stored in the storing unit.

9. An image processing apparatus for receiving an incoming image signal including a PC image signal, an SDTV image signal, or an HDTV image signal output from a video card of a computer and outputting the image signal to a display apparatus, comprising:
an incoming image signal processing module for performing a predetermined a digital image signal process on the incoming image signal based on characteristics of thereof;
a main processing module for selectively capturing and storing the incoming image signal output from the incoming image signal processing module; and
an output signal processing module for selecting one of the incoming image signal output from the incoming image signal processing module and the captured image signal stored in the main processing module and outputting the selected image signal.

10. The image processing apparatus according to claim 9, wherein the incoming image signal processing module comprises:
an LVDS receiving unit for converting a standard low voltage differential signal (LVDS) of the incoming image signal into a digital RGB image signal;
a first multiplexer for selecting one of the digital RGB image signal of the incoming image signal and the digital RGB image signal output from the LVDS receiving unit and outputting the selected digital RGB image signal;
a video decoder for converting an analog CVBS image signal of the incoming image signal to a digital YUV image signal;
a color space conversion unit for converting the digital RGB image signal output from the first multiplexer to a digital YUV image signal; and
a second multiplexer for selecting one of the digital YUV image signal output from the color space conversion unit and the digital YUV image signal output from the video decoder.

11. The image processing apparatus according to claim 10, wherein the incoming image signal processing module further comprise a synchronization detecting unit for detecting a synchronization signal from the digital RGB image signal of the incoming image signal, the digital RGB image signal output from he LVDS receiving unit and the digital YUV image signal output from the video decoder to determine whether or not the incoming image signal is valid.

12. The image processing apparatus according to claim 9, wherein the main processing module comprises:
a down scaler for down-scaling the incoming image signal output from the incoming image signal processing module in size suitable to be stored in a memory;
an image data compressing unit for compressing the down-scaled image signal output from the down scaler;
a flash ROM for storing the compressed image signal;
a up scaler for recovering and up-scaling the stored compressed image in size suitable for a display resolution; and
a memory controller for controlling timings of the flash ROM and the image data compressing unit.

13. The image processing apparatus according to claim 12, wherein the main processing unit comprises:
a color conversion unit for converting the digital YUV image signal output from the up scaler to a digital RGB image signal; and
a digital-to-analog converter for the digital RGB image signal output from the color conversion unit to an analog RGB image signal.

14. The image processing apparatus according to claim 12, wherein the main processing module further comprises a video decoder for converting the digital YUV image signal output from the up scaler to an analog CVBS image signal.

15. The image processing apparatus according to claim 9, wherein the output signal processing module comprises:
a multiplexer for selecting one of the incoming image signal output from the incoming image signal processing module and the captured image signal stored in the main processing module and outputting the selected image signal;
a switching unit for performing an on/off operation to output the digital RGB image signal output from the incoming image signal processing module in response to a predetermined output control signal; and
an LVDS transmitter for converting the digital RGB image signal output from the incoming image signal processing module to a digital LVDS signal.

16. The image processing apparatus according to claim 15, wherein the predetermined output control signal is generated by a control signal inputting unit in accordance with a user's input.

17. The image processing apparatus according to claim 15, wherein the multiplexer selects the captured image signal stored in the main processing module when there is no incoming image signal output from the incoming image signal processing module.

18. The image processing apparatus according to claim 9, further comprising verification module for verifying a right to output the captured image signal stored in the main processing module to the output signal processing module.

19. An image processing apparatus for receiving an incoming analog CVBS image signal input from a TV receiving tuner and outputting the image signal to a display apparatus, comprising:
an image storing/processing unit for selectively capturing the incoming analog CVBS image signal;
a flash ROM for storing the captured image signal output from the image storing/processing unit; and
a multiplexer for selecting one of the incoming analog CVBS image signal and the captured image signal stored in the flash ROM and outputting the selected image signal.

20. The image processing apparatus according to claim 19, wherein the image storing/processing unit comprises an image data compressing unit for compressing the captured image signal.

21. The image processing apparatus according to claim 19, wherein the image storing/processing unit comprises a digital-to-analog conversion unit for converting the incoming analog CVBS image signal input to the image storing/processing unit to a digital image signal.

22. The image processing apparatus according to claim 19, further comprising verification module for verifying a right to output the captured image signal stored in the flash ROM to the multiplexer.

23. The image processing apparatus according to one of claims 1, 9 and 19, further comprising a usage time setting unit for automatically turning on and off the display apparatus in accordance with a set usage time thereof.

24. The image processing apparatus according to claim 1, wherein the image processing apparatus is provided outside the display apparatus.

25. An image processing method of receiving incoming image data and outputting the image data to a display apparatus, comprising steps of:
selectively capturing the received incoming image data;
storing the captured image data; and
selecting one of currently-incoming image data and the captured image data stored in a storing unit and outputting the selected image data to the display apparatus.

26. The image processing method according to claim 25, further comprising, after the step of capturing, a step of compressing the captured image data.

27. The image processing method according to claim 25, wherein the display apparatus is a monitor for displaying one of a SDTV image signal, a PC image signal, and an HDTV image signal.

28. The image processing method according to claim 25, wherein the display apparatus is a TV set for displaying a TV signal.

29. The image processing method according to claim 25, wherein, in the step of capturing, the incoming image data input to the display apparatus is periodically captured.

30. The image processing method according to claim 25, wherein, in the step of selecting and outputting, the image data is selected in accordance with a selection control signal input by a control signal inputting unit.

31. The image processing method according to claim 25, wherein, in the step of selecting and outputting, the image data stored in the storing unit is output to the display apparatus when there is no currently-incoming image data.

32. The image processing method according to claim 25, wherein the step of selecting and outputting further comprises a step of verifying a right to output the captured image data.
